(19) United States
(12) Patent Application Publication
(10) Pub. No.: US 2026/0186141 A1
(43) Pub. Date: Jul. 2, 2026

(54) DISTANCE MEASUREMENT DEVICE

(71) Applicant: FANUC CORPORATION, Yamanashi (JP)

(72) Inventor: Minoru NAKAMURA, Yamanashi (JP)

(21) Appl. No.: 18/865,337

(22) PCT Filed: Jun. 30, 2022
(86) PCT No.: PCT/JP2022/026365

§ 371 Date: Nov. 13, 2024

(51) Int. Cl. G01S 17/42; G01S 7/481

(52) U.S. Cl. CPC G01S 17/42; G01S 7/4816; G01S 7/4817

(57) ABSTRACT

A distance measurement device includes: a light-projection unit beaming light from a light source onto a rotating or swinging mirror, and projecting obtained scanning light onto an object; a light-receiving unit detecting a change in luminance of the object due to the scanning light; a calculation unit calculating the distance to the object based on a scan angle of the scanning light obtained from time information regarding the change in luminance; and a direction-changing unit changing the direction of the scanning light to enable the light-receiving unit to detect reference light in a scan direction. The calculation unit deems time information regarding a change in luminance produced in the light-receiving unit due to reference light whose direction has been changed by the direction-changing unit to be a reference time, and deems time information regarding a change in luminance of the object to be a value relative to the reference time.

### TECHNICAL FIELD

The present invention relates to a distance measurement device.

### BACKGROUND ART

As a distance measurement method based on triangulation using a structured light, a light projection method such as a light section method, a phase shift method, and a space encoding method has been proposed. In the light section method, while scanning an object, a band-shaped slit light is projected onto the object, the object is imaged from an imaging position different from a projection position, and the distance to the object is calculated by triangulation based on a projection angle of the slit light, an incident angle of the slit light onto the imaging surface and a baseline length between the light projection position and the imaging position (e.g., see Patent Literature 1). The projection angle of the slit light can be obtained, for example, from a command value to a scanner or a detection time of a bright line of the slit light appearing on the imaging surface, and the incident angle of the slit light can be obtained, for example, from the incident position of the slit light on the imaging surface. The light section method is said to be highly accurate, but compared to the phase shift method or the spatial code method, the number of images required for a single measurement is greater, and thus there is the problem that the measurement takes a long time.

In recent years, an event-based image sensor, based on a concept different from general frame-based image sensors, has been proposed (e.g., see Patent Literature 2 and 3). The frame-based image sensor outputs frame images at predetermined intervals by being exposed by opening/closing a shutter for a predetermined period of time. On the other hand, the event-based image sensor monitors each pixel independently and asynchronously from moment to moment, and then, when an event (for example, a change in luminance exceeding a predetermined level) is detected, the position, the time point, and the polarity (for example, whether it has become brighter or darker) of the pixel where the event occurred are output as event information. The event-based image sensor has a wider dynamic range than the frame-based image sensor, and is faster because it outputs only event information. Therefore, it is understood that the use of the event-based image sensor will contribute to speeding up of the light section method.

### CITATION LIST

### Patent Literature

[PTL 1] JP 2014-159988 A
[PTL 2] JP 2021-068451 A
[PTL 3] WO 2022/050279 A1

### SUMMARY OF INVENTION

### Technical Problem

While the event-based image sensor, etc., can speed up distance measurement, there is also a demand for technology which enables highly accurate distance measurement. For example, when a rotating mirror is used as a scanner, a photoelectric sensor, etc., is used to detect a specific angle of the mirror. However, a photoelectric sensor has a certain amount of measurement error based on its specifications, etc., and the measurement error may deteriorate an accuracy of the distance measurement.

### Solution to Problem

One aspect of the present disclosure is a distance measurement device comprising: a light projection unit configured to irradiate a light from a light source to a rotating or swinging mirror, and project an obtained scanning light to an object; a light reception unit configured to detect a change in luminance of the object due to the scanning light; a distance information calculation unit configured to calculate a distance to the object based on a scan angle of the scanning light calculated from time information regarding the change in luminance of the object due to the scanning light; and a direction changing unit configured to change a direction of the scanning light so that the light reception unit can detect a reference light in a specific scan direction, wherein the distance information calculation unit is configured to determine the time information regarding the change in luminance generated in the light reception unit due to the reference light, the direction of which has been changed by the direction changing unit, as a reference time, and determine the time information regarding the change in luminance of the object as a relative value from the reference time.

### BRIEF DESCRIPTION OF DRAWINGS

FIG. 1 is a plan view of a stereo camera showing a measurement principle of a stereo method.

FIG. 2 is a plan view of a light-section system showing a measurement principle of a light-section method.

FIG. 3 is a perspective view of a three-dimensional measurement device using the light-section method.

FIG. 4 is a block diagram of a distance measurement device of an embodiment.

FIG. 5 is a schematic configuration view of a distance measurement device according to a first example.

FIG. 6 is a schematic configuration view of a distance measurement device according to a second example.

FIG. 7 is a schematic configuration view of a distance measurement device according to a third example.

### DESCRIPTION OF EMBODIMENTS

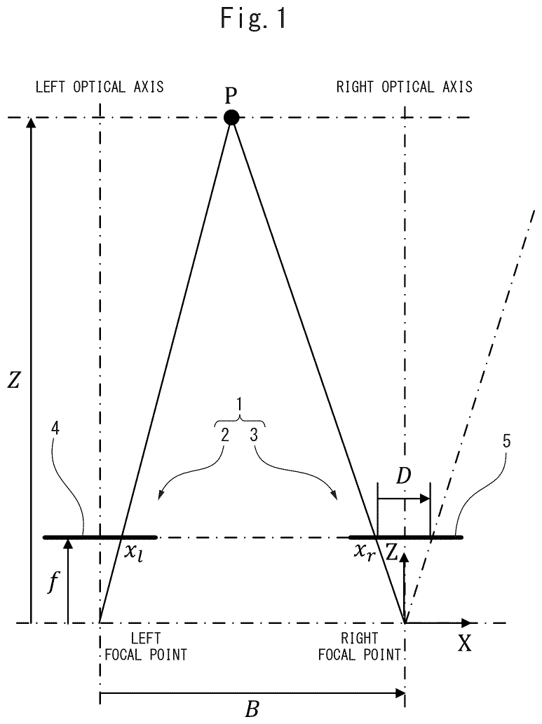

First, a measurement principle of a three-dimensional measurement device of a present embodiment will be described. For easy understanding, measurement principles of a stereo method and a light section method will be described. FIG. 1 is a plan view of a stereo camera 1 showing the measurement principle of the stereo method. The stereo camera 1 has a left light reception unit 2 and a right light reception unit 3 corresponding to two cameras, for example. For example, the left and right light reception units 2 and 3 are arranged so as to be equi-parallel to each other. That is, both of the light reception units are separated by a base line length B, optical axes of the light reception units are arranged in parallel, a left light reception surface 4 and a right light reception surface 5 are arranged in a plane orthogonal to both optical axes, so that the x- and y-directions of each light reception surface are oriented in the same direction. Each light reception surface is, for example, an image sensor in which a plurality of pixels are arranged two-dimensionally, but may be a line sensor, etc., in which a plurality of pixels are arranged one-dimensionally (for example, arranged only in the x-direction).

In this regard, assuming that a position of a pixel on the left light reception surface 4, on which an image of a point P of an object existing in an object space is projected, is determined as xₗ, and a position of a pixel on the right light reception surface 5, on which the image of the point P of the object is projected, is determined as xᵣ, a disparity D between the left and right light reception units 2 and 3 is (xₗ−xᵣ) (D=xₗ−xᵣ). Assuming that the origin of the XYZ coordinate system representing the three-dimensional space is placed at a right focal point, and a focal length of each light reception unit is f, a distance Z to the point P of the object (a depth to the point P (hereinafter, same as above)) is obtained from the following equation 1.

$$[ Math 1 ]$$

$$Z = \frac{Bf}{D} \qquad 1$$

The base line length B and the focal length f are constants determined by the design of the stereo camera 1. Therefore, if the image of the point P on the right light reception surface 5 corresponding to the image of the point P on the left light reception surface 4 can be detected by image processing such as pattern matching, the disparity D can be obtained from a pitch between the pixels of the light reception units, and then the distance Z to the point P of the object can be obtained.

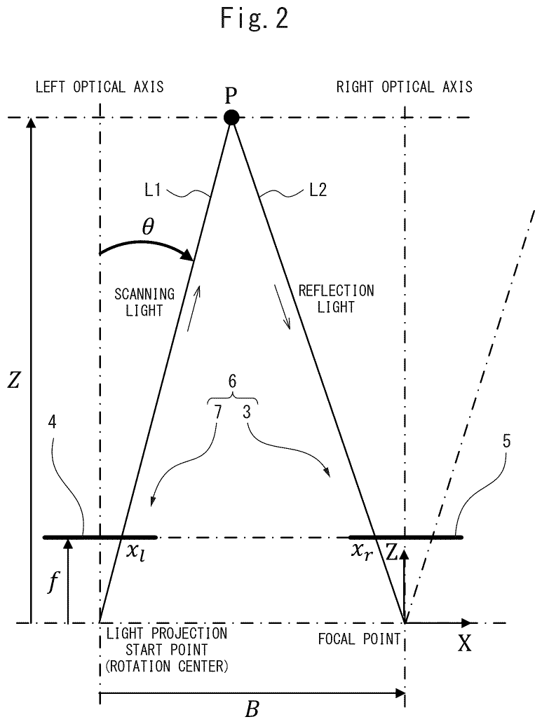

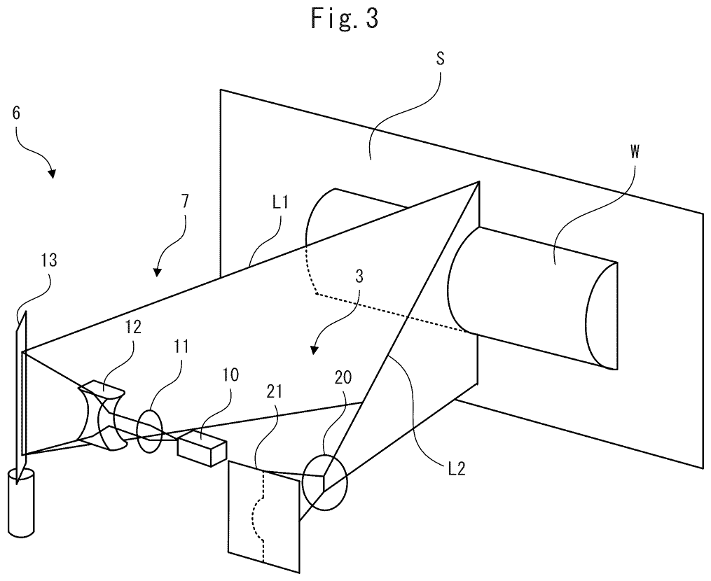

The light section system is obtained by replacing the left light reception unit 2 of the stereo camera 1 with a light projection unit, for example. FIG. 2 is a plan view of the light section system 6 showing the measurement principle of the light section method, and FIG. 3 is a schematic configuration view of the light section system 6. The light section system 6 includes a light projection unit 7 corresponding to, for example, a projector. The light projection unit 7 projects a band-shaped scanning light L1 onto an object W existing in an object space S while scanning the light L1, and the right light reception unit 3 receives a reflection light L2 reflected by the object W.

The light projection unit 7 includes a light source 10 of the scanning light L1, projection optical systems 11 and 12 configured to form a beam of the scanning light L1, and a scanning unit 13 configured to scan the scanning light L1. The light source 10 is constituted by, for example, a semiconductor laser, but is not limited as such. For example, the light source 10 may be constituted by another light source such as a solid-state laser (fiber laser, YAG laser, etc.) or a gas laser (carbon dioxide laser, helium-neon laser, argon laser, etc.). The projection optical systems 11 and 12 are, for example, constituted by beam forming lenses such as collimating lenses or cylindrical lenses. The scanning unit 13 is, for example, constituted by a Galvano scanner or another scanner including an encoder or a photoelectric sensor for detecting a specific scanning direction. The scanning light L1 is emitted from the light source 10, formed into a slit light by the projection optical systems 11 and 12, scanned by the scanning unit 13, and projected onto the object W.

The light reception unit 3 has a light reception optical system 20 configured to receive the reflection light L2 from the object W, and an image sensor 21. The light reception optical system 20 has, for example, a condensing lens. The image sensor 21 has, for example, a plurality of pixels arranged two-dimensionally, but is not limited as such. For example, the image sensor 21 may be constituted by a plurality of pixels arranged one-dimensionally. The reflection light L2 reflected by the object W is condensed by the light reception optical system 20 and received by the image sensor 21 so that a change in luminance of the reflection light is detected.

Herein, assuming that the light projection start point (or a rotation center) is positioned at the left focal point of the stereo camera 1, and a projection angle from the left optical axis of the stereo camera 1 is θ, the pixel position xₗ of the virtual left light reception surface 4 of the light projection unit 7 is obtained by the following equation 2.

$$[ Math 2 ]$$

$${x}_{l} = f tan θ \qquad 2$$

Also, assuming that the light projection unit 7 irradiates the band-shaped scanning light from the light projection start point while rotating about the Y-axis perpendicular to the XZ plane at a constant angular speed ω, the scanning light passes through the left optical axis at a time point to, and the scanning light is projected to the point P of the object at the projection angle θ at time point t, the projection angle θ can be obtained by the following equation 3.

$$[ Math 3 ]$$

$$θ = ω ( t - {t}_{0} ) \qquad 3$$

Therefore, assuming that the reflection light at the point P of the slit light is received at the position xᵣ of the pixel on the right light reception surface 5, the distance Z to the point P of the object can be obtained by substituting equations 2 and 3 into equation 1 as shown in the following equation 4.

$$[ Math 4 ]$$

$$Z = \frac{Bf}{D} = \frac{B f}{f tan ( ω ( t - {t}_{0} ) ) - {x}_{r}} \qquad 4$$

The base line length B, the focal length f, the angular speed @, and the time point to are constants determined by the design of the light section system 6. Therefore, the distance Z to the point P of the object can be obtained by determining the position xᵣ of the pixel on the right light reception surface 5 on which an image of the slit light is projected, and the time point t when the image of the slit light is detected.

However, it should be noted that the above configuration and measurement principle are examples, and that the design can be changed as appropriate according to the design of the system configuration and layout, etc. For example, the light projection unit 7 and the right light reception unit 3 may not be arranged equi-parallel to each other. Further, instead of replacing the left light reception unit 2 with the light projection unit 7, the light projection unit 7 may be prepared in addition to the left and right light reception units 2 and 3 so as to employ a system configuration combining the stereo method and the light section method. Further, the light projection unit 7 may be employed which projects a beam-shaped spot light or a block check-shaped pattern light onto the object, instead of the band-shaped slit light. It should be noted that the calculation method of the three-dimensional information also varies according to such design changes.

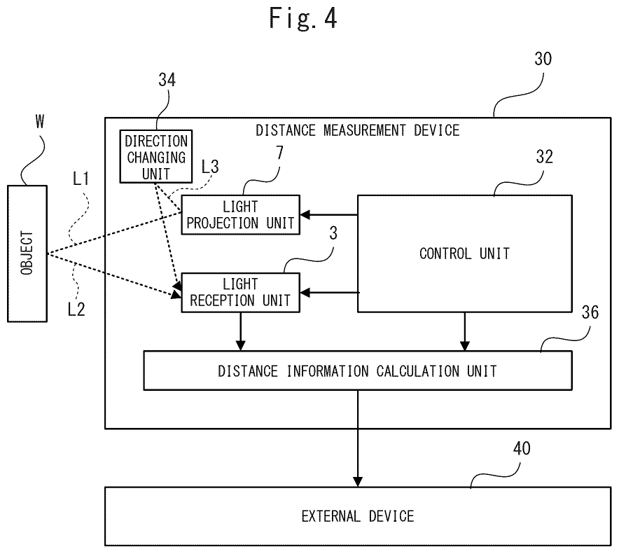

Hereinafter, the configuration of a distance measurement device of an embodiment will be explained. FIG. 4 is a block diagram of an example of a three-dimensional distance measurement device 30. Although not shown, the distance measurement device 30 has a computing device including a processor, a memory and an input/output unit, etc. the processor has, for example, a CPU (central processing unit), and the memory has, for example, a RAM (random access memory) and a ROM (read only memory). The input/output unit is configured to input or output various data used or generated by the processor. The memory is configured to store, for example, a program executed by the processor, and various data used or generated by the processor.

The distance measurement device 30 includes the light projection unit 7 configured to project the scanning light L1 onto the object W while scanning the light, the light reception unit 3 configured to receive the reflection light L2 reflected by the object W at a plurality of pixels, a control unit 32 configured to control the operation of the light projection unit 7 and the light reception unit 3, a direction changing unit 34 configured to change a direction of the light from the light projection unit 7 so that the light is received by the light reception unit 3 without passing through the object W, and a distance information calculation unit 36 configured to calculate three-dimensional information of the object W by triangulation ce to the object based on a scan angle of the scanning light calculated from time information regarding the change in luminance of the object due to the scanning light;

redirecting unit 34 that redirects the light from the light projecting unit 7 without passing through the object W and makes it incident on the light receiving unit 3, and a distance information calculation unit 36 that calculates three-dimensional information of the object W by triangulation based on information output from the light reception unit 3. The light projection unit 7 corresponds to, for example, a projector, the light reception unit 3 corresponds to, for example, a camera, and the control unit 32 and the distance information calculation unit 36 correspond to, for example, a processor. As the scanning light L1, various types of light such as a slit light, a spot light, and a pattern light can be used.

The light projection unit 7 may project a plurality of reference lights while maintaining a predetermined projection angle interval. Since a measurement time of the distance measurement device 30 is determined by a time it takes to scan the object W with the reference light, it is usual to increase the scanning speed in order to shorten the measurement time. However, in such a case, the response speed of the light reception unit 3 becomes a constraint. Therefore, by projecting a plurality of reference lights, it is possible to shorten the measurement time while maintaining the scanning speed under the constraint of the response speed of the light reception unit 3.

The light reception unit 3 has, for example, an image sensor in which a plurality of pixels are arranged two-dimensionally. However, the light reception unit 3 may be a conventional camera, or may have a line sensor in which a plurality of pixels are arranged one-dimensionally, or may be a single light detector (such as a luminance meter) configured to detect a light in a certain direction. A preferred example of the light reception unit 3 is an event-based sensor. In this case, the light reception unit 3 is constituted by a plurality of pixels, and when the amount of change in luminance at each pixel is equal to or larger than a predetermined threshold, the light reception unit 3 outputs the position of the pixel, the time point when the change in luminance occurred, and the polarity indicating the direction of the change in luminance, as an event. In the case of an event-based image sensor, the light reception unit 3 monitors each pixel independently and asynchronously from moment to moment. When the light reception unit 3 detects a predetermined or more event (e.g., a luminance change of a predetermined level or more), the light reception unit 3 outputs event information including the position of the pixel where the event occurred, the time point when the event occurred, and the polarity (e.g., the pixel gets brighter or darker), etc. Alternatively, the sensor of the light reception unit 3 may be a conventional frame-based image sensor. In the case of a frame-based image sensor, the light reception unit 3 opens and closes a shutter for a predetermined period of time for exposure, thereby frame images are output at predetermined time intervals. The frame images include, for example, frame numbers, and luminance information of each pixel, etc.

When the sensor of the light reception unit 3 is an event-based sensor, the pixel where the event (e.g., a luminance change of a predetermined level or more) occurred captures the reflected light from the object, and thus the distance information calculation unit 36 executes distance measurement based on the event information (e.g., the position of the pixel where the luminance is changed, the time point when the luminance is changed, and the polarity) output from the light reception unit 3. Since the slit width of the scanning light and the spot diameter of the spot light may correspond to the size of multiple pixels, the distance measurement may be performed by determining the intermediate time point between when the pixel starts to brighten and when it ends dark. On the other hand, when the sensor of the light reception unit 3 is a frame-based sensor, the distance information calculation unit 36 executes distance measurement detects the position of the pixel with the maximum luminance among the plurality of frame images output from the light reception unit 3 and the frame number (corresponding to the time point), and performs the distance measurement based on the detected information.

Optionally, the distance information calculated by the distance information calculation unit 36 may be output to an external device 40, such as a robot controller or a vehicle controller, provided outside the distance measurement device 30. The output distance information can be used by the external device 40, and for example, the external device 40 can perform position control, speed control and/or acceleration control, etc., based on the three-dimensional information in which the influence of the multiple-reflected reference light is reduced.

### First Example

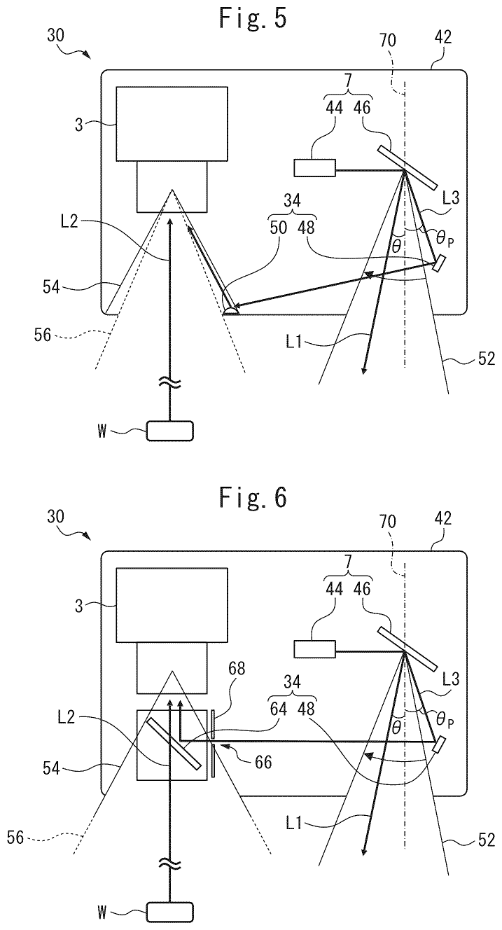

Hereinafter, an embodiment of the distance measurement device 30 will be described, focusing on the function of the direction changing unit 34 in particular. FIG. 5 is a schematic configuration view of the distance measurement device 30 according to a first example. The distance measurement device 30 has a housing 42, and the light projection unit 7 and the light reception unit 3 arranged in the housing 42, and the light projection unit 7 includes a light source 44 and a rotating mirror 46. The rotating mirror may rotate in one direction at a predetermined angular velocity, or may oscillate at a predetermined angular velocity. The light from the light source 44 is reflected by the rotating mirror 46, and progresses to the measurement object W as the scanning light L1 passing through a predetermined scanning direction range (scan range) 52 for the object W, and is reflected by the object W and reaches the light reception unit 3 as the reflected light L2. Here, a method of providing a photoelectric switch (not shown) for detecting a specific angle of the rotating mirror 46, on the premise that the rotating mirror rotates in one direction at a predetermined angular velocity, or oscillates at a predetermined angular velocity, is considered. By detecting a specific angle each time using the photoelectric switch and using the detection time as a reference, it is possible to suppress the influence of fluctuations due to changes over time in rotation or swinging motion and disturbances such as vibrations, and to obtain the projection angle θ of the scanning light L1. However, the photoelectric switch has a certain detection error based on its specifications, etc., and this detection error can become a factor in deteriorating the distance measurement accuracy as the measurement time of the distance measurement device is increased. In addition, when the photoelectric sensor is used, an interface circuit, etc., for transmitting and receiving the output of the photoelectric sensor is also required, which can be a factor in increasing the cost of the entire device.

Therefore, the distance measurement device 30 according to the first example has the direction changing unit 34 configured to determine the scanning light from the light source 44 in a specific scanning direction as a reference light L3, and enable the light reception unit 3 to detect the reference light L3 (in many cases a part of it). Specifically, when the angle of the rotating mirror 46 is such that the light from the light source 44 becomes the reference light L3 which forms an angle θ_{P} with a reference line 70 (corresponding to the left optical axis in FIG. 1 or FIG. 2), the direction changing unit 34 redirects the reference light L3 within the housing 42 so that the light reception unit 3 can detect (receive) the reference light L3. In the first example, the direction changing unit 34 has a fixed mirror 48 and a reflector 50 arranged within the housing 42, and the reference light L3 reflected by the rotating mirror 46 is reflected by the fixed mirror 48 toward the reflector 50, and is further reflected by the reflector 50 to reach the light reception unit 3.

In this regard, when the scanning light forms the angle θ_{P} with the reference line 70 and is detected by the light reception unit 3 as the reference light L3, the projection angle θ is calculated by the following equation 3a using the detection time t_{P} at that time and the above equation 3. Note that in FIG. 5, θ_{P} indicates an angle in the region on the opposite side (negative side) of the scanning direction with respect to the reference line 70, but in such a case, it should be noted that θ_{P} is a negative value.

$$[ Math 5 ]$$

$$θ = ω ( t - {t}_{P} ) + {θ}_{P} \qquad 3 a$$

That is, the scanning angle θ can be calculated from the relative time between the reference time point t_{P} of the luminance change occurring in the light reception unit due to the reference light L3 redirected by the direction changing unit 34 and the time point t of the luminance change due to the reflection light L2 reflected by the object W, and the distance to the object can be calculated. In order to accurately identify the scanning angle θ, it is necessary that the reference time t_{P} is accurate. However, as described above, the photoelectric switch has the detection error. In addition, when the scanning unit 13 is configured using a Galvano scanner and a motor equipped with an encoder, it is possible to output a signal indicating that a specific angle has been detected from motor control systems thereof. However, these control systems usually operate with a dedicated control cycle, and a jitter error caused by the control cycle is superimposed on the output detection signal.

On the other hand, in the first example, the reference light L3 is detected by the light reception unit 3, and therefore the above-mentioned photoelectric switch and the detection signal from the photoelectric switch and the motor control system are not required. Further, since the light reception unit which originally receives the reflection light L2 reflected by the object W is used as is, the time points t_{P} and t in equation 3a are the time points of the luminance change detected by the same light reception unit. Therefore, it is possible to identify the scanning angle θ with very few error factors and with high accuracy. This also applies to second and third examples described below.

In the example of FIG. 5, the reference light L3 is shown as a light outside the scan range 52, but for more accurate distance measurement, it is preferable that the scanning direction of the reference light L3 is a direction adjacent to the scan range 52. If it is adjacent, the reference time point t_{P} and the time point t of the scanning direction θ become closer, and the influence of fluctuations due to the above-mentioned changes over time in the rotational and swinging operations and disturbances such as vibrations can be reduced, thereby expecting even higher accuracy. In this regard, the direction adjacent to the scan range means a state where the distance measurement is not hindered as a distance measurement device, and the reference light is close to the scan range 52 to the extent that the distance measurement device 30 and the direction changing unit 34 can be physically configured, for example, meaning that the minimum angle formed by the reference light L3 and the scan range 52 is within 15°, within 10°, and more preferably within 5°.

However, the scanning direction of the reference light L3 may be within the scan range 52. For example, when the scanning light moves from the right to the left of the field of view of the light reception unit (camera) 3, it is also possible to detect a direction toward a pixel on the left side of the field of view as a specific scanning direction, at the timing when the scanning light begins to appear on the right side of the field of view.

The reflector 50 is preferably disposed within a field of view (angle of view) 54 of the light reception unit (e.g., camera) 3, but outside an angle of view 56 of the distance measurement device. The reflector 50 only needs to have a suitable reflectance so that the light reception unit can detect the light. For example, when an inner surface of the housing 42 has a suitable reflectance, the inner surface can also serve as the reflector 50. Usually, a dark-colored nonwoven fabric with low reflectance is attached to the inner surface of the housing 42 to prevent diffuse reflection, but the reflector 50 can be easily formed by not attaching a nonwoven fabric to a portion corresponding to the reflector 50. There is no particular restriction on the fixed mirror 46, and any type may be used as long as it can direct the reference light L3 to the reflector 50. For example, the mirror 46 may be an angle-adjustable mirror, or may be a part of the inner surface of the housing 42 which has been formed as a mirror-like surface.

In this way, in the first example, by providing the direction changing unit 34 within the housing so that the light reception unit 3 can detect the reference light L3 in the specific scanning direction, it is possible to determine with high accuracy the angle θ of the scanning light when the change in the luminance of the object W is detected. By virtue of this, it is possible to perform highly accurate distance measurement with an extremely short measurement time, for example, by taking advantage of the high speed of the event-based image sensor.

### Second Example

FIG. 6 is a schematic configuration view a distance measurement device 30 according to a second example. In the second example, components different from those of the first example will be mainly described, and the same or similar reference numerals will be given to the same or similar components as those in the first example, and detailed description thereof may be omitted.

In the second example, a half mirror 64 is provided in the housing 42 so that the light reception unit 3 can receive (detect) both the reflection light L2 from the object W and the reference light L3 from the fixed mirror 46. In the first example, the reflector 50 is disposed within the field of view (angle of view) 54 of the light reception unit (e.g., camera) 3, so that the limit is imposed on the field of view 56 of the distance measurement device. However, by using the half mirror, this limit is not imposed, and the field of view 56 of the distance measurement device can be set to a wide range which is the same as the field of view (angle of view) of the light reception unit (e.g., camera) 3. Further, a plate-like member 68 having an opening (e.g., pinhole) 66, through which only the reference light L3 at angle θ_{P} can pass, may be disposed between the fixed mirror 48 and the half mirror 64. By virtue of this, the incidence of unnecessary light into the light reception unit 3 can be reduced. Further, by narrowing the angle range of the angle θ_{P} received by the light reception unit (e.g., camera) 3, the light reception unit 3 can accurately detect the light at angle θ_{P} (in other words, it cannot receive a light close to angle θ_{P}).

### Third Example

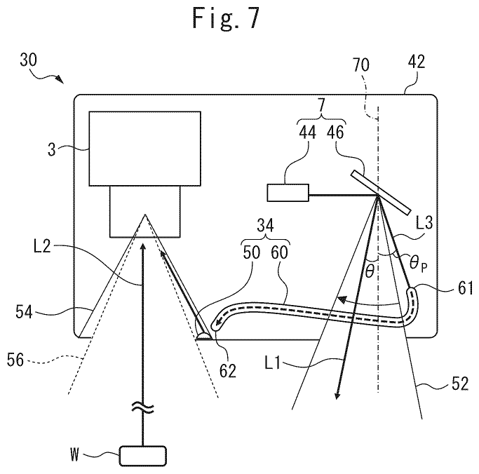

FIG. 7 is a schematic configuration view a distance measurement device 30 according to a third example. In the third example, components different from those of the first example will be mainly described, and the same or similar reference numerals will be given to the same or similar components as those in the first example, and detailed description thereof may be omitted.

In the third example, instead of using the fixed mirror 48, a light guide tube 60 having one end 61 through which the reference light L3 can enter is provided inside the housing 42, so that a light emitted from the other end 62 of the light guide tube 60 is reflected by the reflector 50 similar to that of the first example, and is detected by the light reception unit 3. Alternatively, instead of using the reflector 50, the other end 62 of the light guide tube 60 may be arranged inside the camera angle of view 54 and at the device angle of view 56, so that the light emitted from the other end 62 is directly received by the light reception unit 3.

In the above embodiment, a slit light is used as the scanning light, but the present disclosure is not limited as such. For example, a method of scanning a point light source, such as scanning a field of view of a camera in a raster scan manner using a Galvano mirror or MEMS, can also be applied to the present examples. While the point light source increases the time required to scan the field of view and requires a two-way scanning mechanism, an output of the point light source can be smaller than that of a slit light.

The first, second and third examples described above may be combined as appropriate. For example, the plate 68 having the opening 66 in the second example may be applied to the first or third example.

Although the various embodiments are described herein, it should be noted that the present invention is not limited to the above embodiments, and various modifications can be made within the scope of the claims.

### REFERENCE SIGNS LIST

1 stereo camera
2 left light reception unit
3 right light reception unit
4 left light reception surface
5 right light reception surface (light reception surface)
6 light section system
7 light projection unit
10 light source
11, 12 light projection optical system
13 scanning unit
20 light reception optical system
21 image sensor
30 distance measurement device
32 control unit
34 direction changing unit
36 distance information calculation unit
40 external device
42 housing
44 light source
46 rotating mirror
48 fixed mirror
50 reflector
52 scan range
54 angle of view of camera
56 angle of view of device
60 light guide tube
61, 62 end
64 half mirror
66 opening
68 plate
B base line length
D disparity
f focal length
W object
Z distance to point P of object
θ projection angle

1. A distance measurement device comprising:
a light projection unit configured to irradiate a light from a light source to a rotating or swinging mirror, and project an obtained scanning light to an object;
a light reception unit configured to detect a change in luminance of the object due to the scanning light;
a distance information calculation unit configured to calculate a distance to the object based on a scan angle of the scanning light calculated from time information regarding the change in luminance of the object due to the scanning light; and
a direction changing unit configured to change a direction of the scanning light so that the light reception unit can detect a reference light in a specific scan direction,
wherein the distance information calculation unit is configured to determine the time information regarding the change in luminance generated in the light reception unit due to the reference light, the direction of which has been changed by the direction changing unit, as a reference time, and determine the time information regarding the change in luminance of the object as a relative value from the reference time.

2. The distance measurement device according to claim 1, wherein the light reception unit is constituted by a plurality of pixels, and is configured to, when an amount of the change in luminance in each pixel is equal to or greater than a predetermined threshold, output a position of the pixel, a time point when the change in luminance occurs, and a polarity indicating a direction the change in luminance, as an event.

3. The distance measurement device according to claim 1, wherein the scanning light is a slit light.

4. The distance measurement device according to claim 1, wherein the specific scan direction is a direction adjacent to a range of scan directions to the object.
